(19) United States
(12) Patent Application Publication
(10) Pub. No.: US 2022/0255287 A1
(43) Pub. Date: Aug. 11, 2022

(54) FIBER LASER, AND METHOD FOR OUTPUTTING LASER LIGHT

(71) Applicant: FUJIKURA LTD., Tokyo (JP)

(72) Inventors: Ryokichi Matsumoto, Chiba (JP); Tomoyuki Fujita, Chiba (JP)

(73) Assignee: FUJIKURA LTD., Tokyo (JP)

(21) Appl. No.: 17/626,998

(22) PCT Filed: Jun. 29, 2020
(86) PCT No.: PCT/JP2020/025466

§ 371 Date: Jan. 13, 2022

(30) Foreign Application Priority Data
Jul. 25, 2019 (JP) 2019-137178

(51) Int. Cl. H01S 3/139; H01S 3/067; H01S 3/16; H01S 3/0941; H01S 3/094

(52) U.S. Cl. CPC H01S 3/139; H01S 3/06716; H01S 3/0675; H01S 3/09415; H01S 3/094053; H01S 3/1618

(57) ABSTRACT

A fiber laser includes: a gain fiber; a first low-reflective mirror and a second high-reflective mirror disposed in an optical path of laser light that is emitted from a first end of the gain fiber; a second low-reflective mirror and a first high-reflective mirror disposed in an optical path of laser light that is emitted from a second end of the gain fiber; a first delivery fiber that accepts the laser light emitted from the first end; a second delivery fiber that accepts the laser light emitted from the second end; and an operation mode switching mechanism that switches between a first operation mode and a second operation mode. A first resonator is constituted by the first low-reflective mirror and the first high-reflective mirror. A second resonator, which is constituted by the second low-reflective mirror and the second high-reflective mirror.

### TECHNICAL FIELD

The present invention relates to a fiber laser. The present invention further relates to a method of outputting laser light with use of a fiber laser.

### BACKGROUND

In processing (e.g., cutting, welding, or shaving) of a material (e.g., metal), laser processing, which is excellent in processing accuracy and processing speed, has begun to be used, instead of machining, in which a blade, a drill, or the like is used. As a laser light source used for laser processing, a fiber laser which is configured such that a spot diameter of laser light is easily reduced is particularly promising.

A fiber laser recursively amplifies laser light with use of a resonator which is constituted by a low-reflective mirror that is provided to one end of a gain fiber and a high-reflective mirror that is provided to the other end of the gain fiber. The recursively amplified laser light is outputted outside the resonator through the low-reflective mirror. The gain fiber is typically constituted by a double cladding fiber which includes a core that is doped with a rare earth element. The low-reflective mirror and the high-reflective mirror are each typically constituted by a fiber Bragg grating. As a document which discloses such a fiber laser, Patent Literature 1, for example, is cited.

Note that a fiber laser is not only used as a laser light source for processing, but also sometimes used as a laser light source for communication.

### CITATION LIST

### Patent Literature

[Patent Literature 1]
Japanese Patent Application Publication Tokukai No. 2017-187554

The foregoing fiber laser can output laser light from only one of the mirrors which are provided to the respective ends of the gain fiber (from a low-reflective mirror side). Therefore, the foregoing fiber laser cannot be used flexibly, for example, cannot be used in such a manner that laser light outputted from one of the mirrors is used under certain condition and laser light outputted from the other of the mirrors is used under the other condition. Furthermore, the foregoing fiber laser can output only laser light having a single wavelength (wavelength belonging to an overlap between a reflection wavelength band of the low-reflective mirror and a reflection wavelength band of the high-reflective mirror). Therefore, the foregoing fiber laser cannot be used flexibly, for example, cannot be used in such a manner that laser light having a first wavelength is used under certain condition and laser light having a second wavelength is used under the other condition.

### SUMMARY

One or more embodiments of the present invention realize a fiber laser which is capable of outputting, from both sides thereof, laser light having different wavelengths. Further, one or more embodiments of the present invention is to realize a method of outputting laser light which method allows laser light having different wavelengths to be outputted from both sides of a fiber laser.

According to a fiber laser in accordance with one or more embodiments of the present invention, a configuration is employed in which the fiber laser includes: a gain fiber; a first low-reflective mirror and a second high-reflective mirror which are provided in an optical path of laser light that is emitted from a first end of the gain fiber; a second low-reflective mirror and a first high-reflective mirror which are provided in an optical path of laser light that is emitted from a second end of the gain fiber; a first delivery fiber into which the laser light that is emitted from the first end is inputted; and a second delivery fiber into which the laser light that is emitted from the second end is inputted, the fiber laser being capable of causing at least part of a reflection wavelength band of the first low-reflective mirror to overlap at least part of a reflection wavelength band of the first high-reflective mirror, being capable of causing at least part of a reflection wavelength band of the second low-reflective mirror to overlap at least part of a reflection wavelength band of the second high-reflective mirror, and causing the reflection wavelength band of the first high-reflective mirror not to overlap the reflection wavelength band of the second high-reflective mirror, the fiber laser having a first operation mode and a second operation mode, the first operation mode being a mode in which the laser light that has a first wavelength and that has been recursively amplified by a first resonator, which is constituted by the first low-reflective mirror and the first high-reflective mirror, and has passed through the first low-reflective mirror is outputted from the first delivery fiber, the second operation mode being a mode in which the laser light that has a second wavelength and that has been recursively amplified by a second resonator, which is constituted by the second low-reflective mirror and the second high-reflective mirror, and has passed through the second low-reflective mirror is outputted from the second delivery fiber, the fiber laser further comprising an operation mode switching mechanism which switches between the first operation mode and the second operation mode.

According to a method of outputting laser light in accordance with one or more embodiments of the present invention, a configuration is employed in which the method includes: a first step of outputting, from a first delivery fiber, laser light which has been recursively amplified by a first resonator and has passed through a first low-reflective mirror, the first resonator being constituted by the first low-reflective mirror which is provided in an optical path of laser light that is emitted from a first end of a gain fiber and a first high-reflective mirror which is provided in an optical path of laser light that is emitted from a second end of the gain fiber; a second step of outputting, from a second delivery fiber, laser light which has been recursively amplified by a second resonator and has passed through a second low-reflective mirror, the second resonator being constituted by the second low-reflective mirror which is provided in the optical path of the laser light that is emitted from the second end of the gain fiber and a second high-reflective mirror which is provided in the optical path of the laser light that is emitted from the first end of the gain fiber; and a switching step of switching between the first step and the second step.

According to one or more embodiments of the present invention, it is possible to realize a fiber laser which is capable of outputting, from both sides thereof, laser light having different wavelengths. Furthermore, according to one or more embodiments of the present invention, it is possible to realize a method of outputting laser light which method allows laser light having different wavelengths to be outputted from both sides of a fiber laser.

### BRIEF DESCRIPTION OF DRAWINGS

FIG. 1 is a block diagram illustrating a configuration of a fiber laser in accordance with one or more embodiments of the present invention.

FIG. 2 is a drawing illustrating, in relation to the fiber laser illustrated in FIG. 1, a relationship between reflection wavelength bands of a first low-reflective mirror, a second low-reflective mirror, a first high-reflective mirror, and a second high-reflective mirror before and after the reflection wavelength band of the first low-reflective mirror is shifted.

FIG. 3 is a drawing illustrating, in relation to the fiber laser illustrated in FIG. 1, a relationship between the reflection wavelength bands of the first low-reflective mirror, the second low-reflective mirror, the first high-reflective mirror, and the second high-reflective mirror before and after the reflection wavelength band of the second low-reflective mirror is shifted.

FIG. 4 is a block diagram illustrating Variation 1 of the fiber laser illustrated in FIG. 1.

FIGS. 5A and 5B are block diagrams illustrating Variation 2 of the fiber laser illustrated in FIG. 1.

FIG. 6 is a block diagram illustrating Variation 3 of the fiber laser illustrated in FIG. 1.

### DETAILED DESCRIPTION

(Configuration of Fiber Laser)

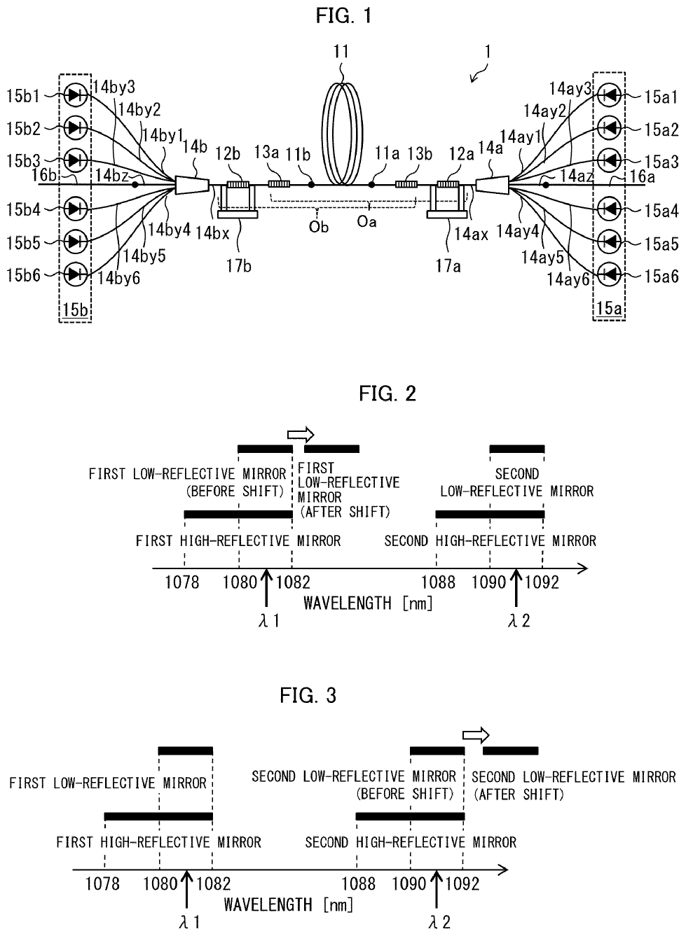

The following description will discuss a configuration of a fiber laser 1 in accordance with one or more embodiments of the present invention with reference to FIG. 1. FIG. 1 is a block diagram illustrating the configuration of the fiber laser 1.

The fiber laser 1, as illustrated in FIG. 1, includes a gain fiber 11, low-reflective mirrors 12a and 12b, high-reflective mirrors 13a and 13b, pump combiners 14a and 14b, pumping light source groups 15a and 15b, and delivery fibers 16a and 16b.

The gain fiber 11 is an optical fiber having a function of amplifying laser light with use of energy of pumping light.

Note that, in one or more embodiments, a double cladding fiber which includes a core doped with a rare earth element is used as the gain fiber 11. Note, however, that the gain fiber 11 is not limited to the double cladding fiber. That is, any optical fiber can be used as the gain fiber 11, provided that the any optical fiber includes a waveguide (corresponding to a core) through which laser light is guided and a waveguide (corresponding to a cladding) through which pumping light is guided. Note also that, in one or more embodiments, ytterbium is used as the rare earth element with which the core is doped. Note, however, that the rare earth element with which the core is doped is not limited to ytterbium. For example, the core may be doped with any rare earth element other than ytterbium, such as thulium, cerium, neodymium, europium, or erbium.

The first low-reflective mirror 12a and the second high-reflective mirror 13b are provided in an optical path of laser light which is emitted from a first end 11a of the gain fiber 11. The second low-reflective mirror 12b and the first high-reflective mirror 13a are provided in an optical path of laser light which is emitted from a second end 11b of the gain fiber 11. The first high-reflective mirror 13a and the second high-reflective mirror 13b are configured so that reflection wavelength bands of the first high-reflective mirror 13a and the second high-reflective mirror 13b do not overlap each other and a resonator is not constituted by the first high-reflective mirror 13a and the second high-reflective mirror 13b. Note that a reflection wavelength band refers to a range of wavelengths a reflectance with respect to each of which differs, by not more than 20 dB, from a maximum reflectance (reflectance with respect to a wavelength with respect to which the reflectance is maximized).

According to the fiber laser 1, it is possible to cause at least part of a reflection wavelength band of the first low-reflective mirror 12a and at least part of the reflection wavelength band of the first high-reflective mirror 13a to overlap each other as described later. In so doing, the first low-reflective mirror 12a and the first high-reflective mirror 13a provided to the respective ends of the gain fiber 11 constitute a first resonator Oa which recursively amplifies laser light which has a wavelength of λa belonging to an overlap between the reflection wavelength bands of these two mirrors. A reflectance (e.g., not more than 10%) of the first low-reflective mirror 12a with respect to the wavelength of λa is lower than a reflectance (e.g., not less than 95%) of the first high-reflective mirror 13a with respect to the wavelength of λa. Therefore, the laser light which has the wavelength of λa and which has been recursively amplified in the first resonator Oa is mainly outputted outside the first resonator Oa through the first low-reflective mirror 12a.

Note here that, in one or more embodiments, the first high-reflective mirror 13a and the second low-reflective mirror 12b are disposed so that the first high-reflective mirror 13a is closer to the second end 11b of the gain fiber 11 than the second low-reflective mirror 12b. That is, the second low-reflective mirror 12b is disposed outside the first resonator Oa. Therefore, it is possible to reduce a possibility that recursive amplification of laser light in the first resonator Oa is prevented by the second low-reflective mirror 12b.

Furthermore, according to the fiber laser 1, it is possible to cause at least part of a reflection wavelength band of the second low-reflective mirror 12b and at least part of the reflection wavelength band of the second high-reflective mirror 13b to overlap each other as described later. In so doing, the second low-reflective mirror 12b and the second high-reflective mirror 13b provided to the respective ends of gain fiber 11 constitute a second resonator Ob which recursively amplifies laser light which has a wavelength of λb belonging to an overlap between the reflection wavelength bands of these two mirrors. A reflectance (e.g., not more than 10%) of the second low-reflective mirror 12b with respect to the wavelength of λb is lower than a reflectance (e.g., not less than 95%) of the second high-reflective mirror 13b with respect to the wavelength of λb. Therefore, the laser light which has the wavelength of λb and which has been recursively amplified in the second resonator Ob is mainly outputted outside the second resonator Ob through the second low-reflective mirror 12b.

Note here that, in one or more embodiments, the second high-reflective mirror 13b and the first low-reflective mirror 12a are disposed so that the second high-reflective mirror 13b is closer to the first end 11a of the gain fiber 11 than the first low-reflective mirror 12a. That is, the first low-reflective mirror 12a is disposed outside the second resonator Ob. Therefore, it is possible to reduce a possibility that recursive amplification of laser light in the second resonator Ob is prevented by the first low-reflective mirror 12a.

Note that, in one or more embodiments, a fiber Bragg grating (optical fiber including a core in which a Bragg grating is written) is used as each of the first low-reflective mirror 12a, the second low-reflective mirror 12b, the first high-reflective mirror 13a, and the second high-reflective mirror 13b. Note here that an optical fiber in which a Bragg grating is written and which functions as each of the first low-reflective mirror 12a, the second low-reflective mirror 12b, the first high-reflective mirror 13a, and the second high-reflective mirror 13b may be an optical fiber which is different from the gain fiber 11 and which is fused with the gain fiber 11 or may be alternatively the gain fiber 11. Note, however, that each of the first low-reflective mirror 12a, the second low-reflective mirror 12b, the first high-reflective mirror 13a, and the second high-reflective mirror 13b are not limited to the fiber Bragg grating. Any mirror can be used as each of the first low-reflective mirror 12a and the second low-reflective mirror 12b, provided that a reflectance of the any mirror with respect to the wavelength of λa and the wavelength of λb is lower (e.g., not more than 10%) than that of each of the first high-reflective mirror 13a and the second high-reflective mirror 13b. Further, any mirror can be used as each of the first high-reflective mirror 13a and the second high-reflective mirror 13b, provided that a reflectance of the any mirror with respect to the wavelength of λa and the wavelength of λb is higher (e.g., not less than 95%) than that of each of the first low-reflective mirror 12a and the second low-reflective mirror 12b.

The first pump combiner 14a includes at least one resonator-side port 14ax, at least m light source group-side input ports 14ay1 through 14aym (m is any natural number which represents the number of pumping light sources constituting the first pumping light source group 15a), and at least one light source group-side output port 14az. The resonator-side port 14ax of the first pump combiner 14a is connected to the first end 11a of the gain fiber 11 via the first low-reflective mirror 12a and the second high-reflective mirror 13b. A light source group-side input port 14ayi (i=1, 2, . . . , m) of the first pump combiner 14a is connected to a pumping light source 15ai constituting the first pumping light source group 15a. Pumping light generated by each of pumping light sources 15al through 15am is inputted into a cladding of the gain fiber 11 through the first pump combiner 14a, and is used to cause a transition of the rare earth element, with which the core of the gain fiber 11 is doped, to a population inversion state. The light source group-side output port 14az of the first pump combiner 14a is connected to the first delivery fiber 16a. The laser light which has the wavelength of λa and which has been generated in the first resonator Oa is inputted into the first delivery fiber 16a through the first pump combiner 14a.

Note that, in one or more embodiments, a laser diode is used as each of the pumping light sources 15al through 15am. Note, however, that each of the pumping light sources 15al through 15am is not limited to the laser diode. That is, any light source can be used as each of the pumping light sources 15al through 15am, provided that the any light source is capable of emitting light that enables a transition of the rare earth element, with which the core of the gain fiber 11 is doped, to a population inversion state. Note also that, in one or more embodiments, a few-mode fiber is used as the first delivery fiber 16a. Note, however, that the first delivery fiber 16a is not limited to the few-mode fiber. That is, a single-mode fiber or a multimode fiber other than the few-mode fiber can be used as the first delivery fiber 16a, provided that the single-mode fiber or the multimode fiber is an optical fiber which allows laser light outputted from the first resonator Oa to be guided therethrough. Note that a few-mode fiber indicates, among multimode fibers (optical fibers having two or more guide modes), an optical fiber having 25 or less guide modes.

The second pump combiner 14b includes at least one resonator-side port 14bx, at least n light source group-side input ports 14byl through 14byn (n is any natural number which represents the number of pumping light sources constituting the second pumping light source group 15b), and at least one light source group-side output port 14bz. The resonator-side port 14bx of the second pump combiner 14b is connected to the second end 11b of the gain fiber 11 via the second low-reflective mirror 12b and first high-reflective mirror 13a. A light source group-side input port 14byj (j=1, 2, . . . , n) of the second pump combiner 14b is connected to a pumping light source 15bj constituting the second pumping light source group 15b. Pumping light generated by each of pumping light sources 15b1 through 15bn is inputted into the cladding of the gain fiber 11 through the second pump combiner 14b, and is used to cause a transition of the rare earth element, with which the core of the gain fiber 11 is doped, to a population inversion state. The light source group-side output port 14bz of the second pump combiner 14b is connected to the second delivery fiber 16b. The laser light which has the wavelength of λb and which has been generated in the second resonator Ob is inputted into the second delivery fiber 16b through the second pump combiner 14b.

Note that, in one or more embodiments, a laser diode is used as each of the pumping light sources 15b1 through 15bn. Note, however, that each of the pumping light sources 15b1 through 15bn is not limited to the laser diode. That is, any light source can be used as each of the pumping light sources 15b1 through 15bn, provided that the any light source is capable of emitting light that enables a transition of the rare earth element, with which the core of the gain fiber 11 is doped, to a population inversion state. Note also that, in one or more embodiments, a few-mode fiber is used as the second delivery fiber 16b. Note, however, that the second delivery fiber 16b is not limited to the few-mode fiber. That is, a single-mode fiber or a multimode fiber other than the few-mode fiber can be used as the second delivery fiber 16b, provided that the single-mode fiber or the multimode fiber is an optical fiber which allows laser light outputted from the second resonator Ob to be guided therethrough.

In one or more embodiments, the fiber laser 1 is realized as a fiber laser of a bidirectional pumping type which includes the first pumping light source group 15a and the second pumping light source group 15b. However, the present invention is not limited to such a configuration. That is, the fiber laser 1 can be alternatively realized as a fiber laser of a unidirectional pumping type which includes only the first pumping light source group 15a or can be alternatively realized as a fiber laser of a unidirectional pumping type which includes only the second pumping light source group 15b. Further, the fiber laser 1 is not limited to these fiber lasers of an end-pumping type, and may be a fiber laser of a side-pumping type. Note that a fiber laser of an end-pumping type indicates a fiber laser configured such that pumping light is inputted into a gain fiber from an end face of the gain fiber and a fiber laser of a side-pumping type indicates a fiber laser configured such that pumping light is inputted into a gain fiber from a side face of the gain fiber.

(Operation of Fiber Laser)

Operation of the fiber laser 1 is described below with reference to FIGS. 2 and 3.

The fiber laser 1 can have three operation modes described below.

A first operation mode is an operation mode in which the laser light which has the wavelength of λa and which has been amplified in the first resonator Oa is outputted through the first low-reflective mirror 12a. In the first operation mode, energy of pumping light emitted from the pumping light source groups 15a and 15b is mainly consumed in amplification of the laser light which has the wavelength of λa in the first resonator Oa. Therefore, amplification of the laser light which has the wavelength λb in the second resonator Ob is not carried out or, even if the amplification is carried out, the amplification is carried out to such an extent that the amplification can be ignored. The first operation mode is realized in a case where a gain of the first resonator Oa is higher than that of the second resonator Ob. Note that the gain of the first resonator Oa indicates a gain also taking into account a loss in an optical waveguide constituting the first resonator Oa (in one or more embodiments, optical waveguide constituted by the first low-reflective mirror 12a, the second high-reflective mirror 13b, the gain fiber 11, and the first high-reflective mirror 13a). Similarly, the gain of the second resonator Ob indicates a gain also taking into account a loss in an optical waveguide constituting the second resonator Ob (in one or more embodiments, optical waveguide constituted by the second low-reflective mirror 12b, the first high-reflective mirror 13a, the gain fiber 11, and the second high-reflective mirror 13b).

A second operation mode is an operation mode in which the laser light which has the wavelength of λb and which has been amplified in the second resonator Ob is outputted through the second low-reflective mirror 12b. In the second operation mode, energy of pumping light emitted from the pumping light source groups 15a and 15b is mainly consumed in amplification of the laser light which has the wavelength of λb in the second resonator Ob. Therefore, amplification of the laser light which has the wavelength λa in the first resonator Oa is not carried out or, even if the amplification is carried out, the amplification is carried out to such an extent that the amplification can be ignored. The second operation mode is realized in a case where the gain of the second resonator Ob is higher than that of the first resonator Oa.

A third operation mode is an operation mode in which the laser light which has the wavelength of λa and which has been amplified in the first resonator Oa is outputted through the first low-reflective mirror 12a and the laser light which has the wavelength of λb and which has been amplified in the second resonator Ob is outputted through the second low-reflective mirror 12b. In the third operation mode, energy of pumping light emitted from the pumping light source groups 15a and 15b is used for amplification of the laser light which has the wavelength of λa in the first resonator Oa and amplification of the laser light which has the wavelength of λb in the second resonator Ob. The third operation mode is realized in a case where the gain of the first resonator Oa and the gain of the second resonator Ob are exactly equal to each other.

The fiber laser 1 has, as mechanisms for switching between the operation modes (corresponding to an “operation mode switching mechanism” in the claims), a first reflection wavelength band changing mechanism 17a and a second reflection wavelength band changing mechanism 17b.

The first reflection wavelength band changing mechanism 17a is a mechanism for changing the reflection wavelength band of the first low-reflective mirror 12a. In one or more embodiments, as the first reflection wavelength band changing mechanism 17a, a mechanism which changes tension acting on the fiber Bragg grating functioning as the first low-reflective mirror 12a is employed. In a case where the tension acting on the fiber Bragg grating is increased, a period of the fiber Bragg grating is extended and the reflection wavelength band of the first low-reflective mirror 12a is shifted to a long wavelength side. Conversely, in a case where the tension acting on the fiber Bragg grating is reduced, the period of the fiber Bragg grating is shortened and the reflection wavelength band of the first low-reflective mirror 12a is shifted to a short wavelength side.

FIG. 2 is a drawing illustrating a relationship between the reflection wavelength bands of the first low-reflective mirror 12a, the second low-reflective mirror 12b, the first high-reflective mirror 13a, and the second high-reflective mirror 13b before and after the first reflection wavelength band changing mechanism 17a shifts the reflection wavelength band of the first low-reflective mirror 12a to the long wavelength side.

A bandwidth of the reflection wavelength band of the first low-reflective mirror 12a is set to, for example, not less than 0.3 nm but not more than 3 nm (2 nm in an example shown in FIG. 2). A bandwidth of the reflection wavelength band of the first high-reflective mirror 13a is set to, for example, not less than 4 nm but not more than 5 nm (4 nm in the example shown in FIG. 2). The central wavelength of the reflection wavelength band of the first low-reflective mirror 12a is set to, for example, 1081 nm. The central wavelength of the reflection wavelength band of the first high-reflective mirror 13a is set to, for example, 1080 nm.

As illustrated in FIG. 2, in a case where the reflection wavelength band of the first low-reflective mirror 12a is shifted to the long wavelength side, the overlap between the reflection wavelength band of the first low-reflective mirror 12a and the reflection wavelength band of the first high-reflective mirror 13a is reduced (in the example shown in FIG. 2, a case where an amount of a shift is less than 2 nm) or disappears (in the example shown in FIG. 2, a case where the amount of the shift is not less than 2 nm). Consequently, the gain of the second resonator Ob becomes higher than the gain of the first resonator Oa, and a transition to the second operation mode described above is realized. Note that FIG. 2 illustrates a configuration in which the reflection wavelength band of the first low-reflective mirror 12a is included in the reflection wavelength band of the first high-reflective mirror 13a before the reflection wavelength band of the first low-reflective mirror 12a is shifted, but the present invention is not limited to such a configuration. For example, the upper limit wavelength of the reflection wavelength band of the first high-reflective mirror 13a may be shorter than the upper limit wavelength of the reflection wavelength band of the first low-reflective mirror 12a. This allows a transition to the second operation mode even in a case where the reflection wavelength band of the first low-reflective mirror 12a is shifted in a smaller amount.

In one or more embodiments, as the first reflection wavelength band changing mechanism 17a, the mechanism which changes the tension acting on the fiber Bragg grating functioning as the first low-reflective mirror 12a is employed. However, the present invention is not limited such a configuration. For example, a mechanism which changes, with use of a Peltier element or the like, a temperature of the fiber Bragg grating functioning as the first low-reflective mirror 12a may be employed as the first reflection wavelength band changing mechanism 17a. In this case, in a case where the temperature of the fiber Bragg grating is raised, the period of the fiber Bragg grating is extended mainly due to thermal expansion of glass, and the reflection wavelength band of the first low-reflective mirror 12a is consequently shifted to the long wavelength side. Conversely, in a case where the temperature of the fiber Bragg grating is lowered, the period of the fiber Bragg grating is shortened mainly due to thermal contraction of glass, and the reflection wavelength band of the first low-reflective mirror 12a is consequently shifted to the short wavelength side.

The second reflection wavelength band changing mechanism 17b is a mechanism for changing the reflection wavelength band of the second low-reflective mirror 12b. In one or more embodiments, as the second reflection wavelength band changing mechanism 17b, a mechanism which changes tension acting on the fiber Bragg grating functioning as the second low-reflective mirror 12b is employed. In a case where the tension acting on the fiber Bragg grating is increased, a period of the fiber Bragg grating is extended and the reflection wavelength band of the second low-reflective mirror 12b is shifted to the long wavelength side. Conversely, in a case where the tension acting on the fiber Bragg grating is reduced, the period of the fiber Bragg grating is shortened and the reflection wavelength band of the second low-reflective mirror 12b is shifted to the short wavelength side.

FIG. 3 is a drawing illustrating a relationship between the reflection wavelength bands of the first low-reflective mirror 12a, the second low-reflective mirror 12b, the first high-reflective mirror 13a, and the second high-reflective mirror 13b before and after the second reflection wavelength band changing mechanism 17b shifts the reflection wavelength band of the second low-reflective mirror 12b to the long wavelength side.

A bandwidth of the reflection wavelength band of the second low-reflective mirror 12b is set to, for example, not less than 0.3 nm but not more than 3 nm (2 nm in an example shown in FIG. 3). A bandwidth of the reflection wavelength band of the second high-reflective mirror 13b is set to, for example, not less than 4 nm but not more than 5 nm (4 nm in the example shown in FIG. 3). The central wavelength of the reflection wavelength band of the first second low-reflective mirror 12b is set to, for example, 1091 nm. The central wavelength of the reflection wavelength band of the second high-reflective mirror 13b is set to, for example, 1090 nm.

As illustrated in FIG. 3, in a case where the reflection wavelength band of the second low-reflective mirror 12b is shifted to the long wavelength side, the overlap between the reflection wavelength band of the second low-reflective mirror 12b and the reflection wavelength band of the second high-reflective mirror 13b is reduced (in the example shown in FIG. 3, a case where an amount of a shift is less than 2 nm) or disappears (in the example shown in FIG. 3, a case where the amount of the shift is not less than 2 nm). Consequently, the gain of the first resonator Oa becomes higher than the gain of the second resonator Ob, and a transition to the first operation mode described above is realized. Note that FIG. 3 illustrates a configuration in which the reflection wavelength band of the second low-reflective mirror 12b is included in the reflection wavelength band of the second high-reflective mirror 13b before the reflection wavelength band of the second low-reflective mirror 12b is shifted, but the present invention is not limited to such a configuration. For example, the upper limit wavelength of the reflection wavelength band of the second high-reflective mirror 13b may be shorter than the upper limit wavelength of the reflection wavelength band of the second low-reflective mirror 12b. This allows a transition to the first operation mode even in a case where the reflection wavelength band of the second low-reflective mirror 12b is shifted in a smaller amount.

In one or more embodiments, as the second reflection wavelength band changing mechanism 17b, the mechanism which changes the tension acting on the fiber Bragg grating functioning as the second low-reflective mirror 12b is employed. However, the present invention is not limited such a configuration. For example, a mechanism which changes, with use of a Peltier element or the like, a temperature of the fiber Bragg grating functioning as the second low-reflective mirror 12b may be employed as the second reflection wavelength band changing mechanism 17b. In this case, in a case where the temperature of the fiber Bragg grating is raised, the period of the fiber Bragg grating is extended mainly due to thermal expansion of glass, and the reflection wavelength band of the second low-reflective mirror 12b is consequently shifted to the long wavelength side. Conversely, in a case where the temperature of the fiber Bragg grating is lowered, the period of the fiber Bragg grating is shortened mainly due to thermal contraction of glass, and the reflection wavelength band of the second low-reflective mirror 12b is consequently shifted to the short wavelength side.

In one or more embodiments, a configuration is employed in which both the reflection wavelength band of the first low-reflective mirror 12a and the reflection wavelength band of the second low-reflective mirror 12b are changed. However, the present invention is not limited such a configuration. For example, a configuration may be alternatively employed in which one of the reflection wavelength band of the first low-reflective mirror 12a and the reflection wavelength band of the second low-reflective mirror 12b is changed or a configuration may be alternatively employed in which one or both of the reflection wavelength band of the first high-reflective mirror 13a and the reflection wavelength band of the second high-reflective mirror 13b is/are changed. More generally speaking, it is only necessary to employ a configuration in which the reflection wavelength band of at least one mirror, among the first low-reflective mirror 12a, the second low-reflective mirror 12b, the first high-reflective mirror 13a, and the second high-reflective mirror 13b, is changed. This is because it is sufficient to change a magnitude relationship between the gain of the first resonator Oa and the gain of the second resonator Ob in order to realize switching between the operation modes.

(Variation 1 of Fiber Laser)

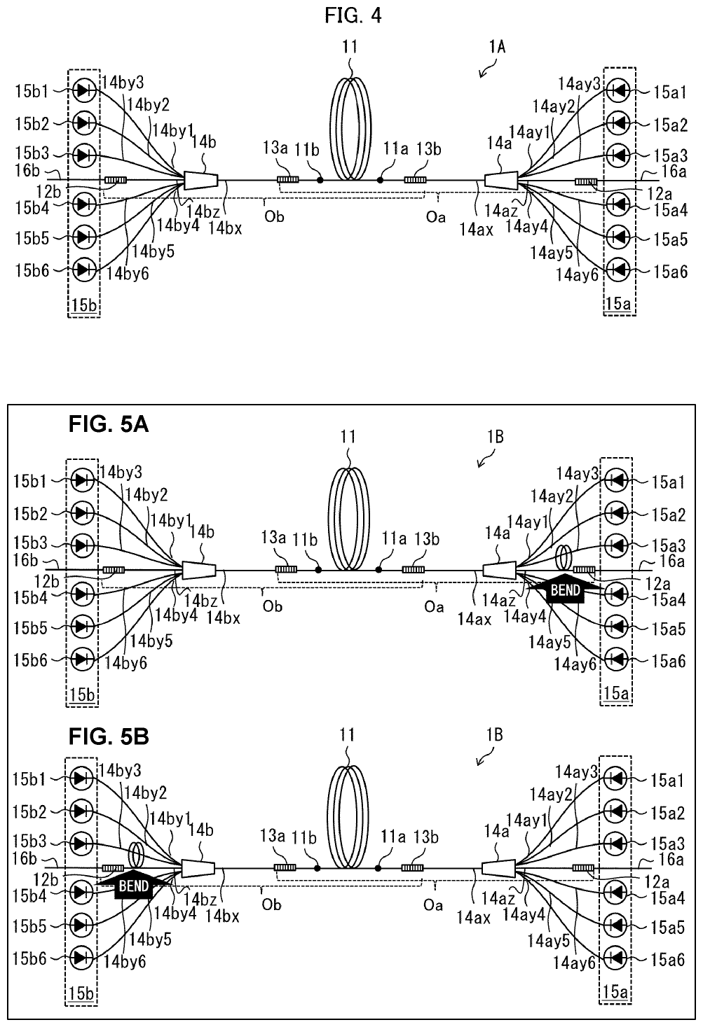

Variation 1 of the fiber laser 1 (hereinafter, also referred to as a “fiber laser 1A”) will be described below with reference to FIG. 4. FIG. 4 is a block diagram illustrating a configuration of a fiber laser 1A in accordance with Variation 1. Note that, in FIG. 4, a first reflection wavelength band changing mechanism 17a and a second reflection wavelength band changing mechanism 17b are omitted.

The fiber laser 1A illustrated in FIG. 4 is different from the fiber laser 1 illustrated in FIG. 1 in disposition of a first low-reflective mirror 12a and a second low-reflective mirror 12b.

That is, in the fiber laser 1 illustrated in FIG. 1, the first low-reflective mirror 12a is disposed on a resonator side of the first pump combiner 14a, and the second low-reflective mirror 12b is disposed on a resonator side of the second pump combiner 14b. Therefore, the first low-reflective mirror 12a inevitably receives pumping light generated by the first pumping light source group 15a, and the second low-reflective mirror 12b inevitably receives pumping light generated by the second pumping light source group 15b.

In contrast, in the fiber laser 1A illustrated in FIG. 4, the first low-reflective mirror 12a is disposed on a light source group side of a first pump combiner 14a, and the second low-reflective mirror 12b is disposed on a light source group side of a second pump combiner 14b. In other words, (1) the first pump combiner 14a which supplies pumping light to a gain fiber 11 from a first end 11a side is provided between a second high-reflective mirror 13b and the first low-reflective mirror 12a and (2) the second pump combiner 14b which supplies pumping light to the gain fiber 11 from a second end 11b side is provided between a first high-reflective mirror 13a and the second low-reflective mirror 12b. Therefore, the first low-reflective mirror 12a is prevented from receiving pumping light generated by a first pumping light source group 15a, and the second low-reflective mirror 12b is prevented from receiving pumping light generated by a second pumping light source group 15b.

Therefore, according to the fiber laser 1A illustrated in FIG. 4, it is possible to suppress a decrease in long-term reliability of the first low-reflective mirror 12a and the second low-reflective mirror 12b which decrease in long-term reliability is caused by entry of pumping light into the first low-reflective mirror 12a and the second low-reflective mirror 12b. For example, a fiber Bragg grating is manufactured by carrying out the following steps in order: (1) removing a coating of an optical fiber; (2) writing a grating in a core of the optical fiber; and (3) recoating the optical fiber. Therefore, according to the fiber Bragg grating, there is a possibility that a foreign matter which has been incorporated at a time of recoating remains on a surface of a cladding. Such a foreign matter causes generation of heat when pumping light is inputted into the cladding. However, according to the fiber laser 1A illustrated in FIG. 4, even in a case where the first low-reflective mirror 12a and the second low-reflective mirror 12b are each constituted by a fiber Bragg grating, generation of heat is less likely to be caused by a foreign matter which has been incorporated at a time of recoating. Furthermore, according to the fiber laser 1A illustrated in FIG. 4, it is possible to suppress a loss of pumping light which loss of pumping light is caused by entry of the pumping light into the first low-reflective mirror 12a and the second low-reflective mirror 12b. Moreover, according to the fiber laser 1A illustrated in FIG. 4, it is easy to adjust reflection wavelength bands of the first low-reflective mirror 12a and the second low-reflective mirror 12b with use of a first reflection wavelength band changing mechanism 17a and a second reflection wavelength band changing mechanism 17b. Reasons for this feature include the following: (1) an amount of heat generated due to entry of pumping light into the first low-reflective mirror 12a and the second low-reflective mirror 12b is small; and (2) in a case where the first low-reflective mirror 12a and the second low-reflective mirror 12b are each constituted by a fiber Bragg grating, it is possible to reduce a diameter of an optical fiber constituting the Bragg grating, so that it is possible to reduce tension which is caused to act on the first low-reflective mirror 12a and the second low-reflective mirror 12b in order to shift the reflection wavelength bands. Note that it is possible to reduce the diameter of the optical fiber constituting the Bragg grating for the following reason. That is, this is because a diameter of a glass part of an optical fiber which constitutes each of a delivery fiber 16a which is connected to the first low-reflective mirror 12a, a delivery fiber 16b which is connected to the second low-reflective mirror 12b, a light source group-side output port 14az of the first pump combiner 14a, and a light source group-side output port 14bz of the second pump combiner 14b of the fiber laser 1A illustrated in FIG. 4 is smaller than a diameter of a glass part of an optical fiber which constitutes each of the gain fiber 11 which is connected to the first low-reflective mirror 12a and the second low-reflective mirror 12b, the resonator-side port 14ax of the first pump combiner 14a, and the resonator-side port 14bx of the second pump combiner 14b of the fiber laser 1 illustrated in FIG. 1.

(Variation 2 of Fiber Laser)

Variation 2 of the fiber laser 1 (hereinafter, also referred to as a “fiber laser 1B”) will be described below with reference to FIGS. 5A and 5B. FIGS. 5A and 5B are block diagrams illustrating a configuration of a fiber laser 1B in accordance with Variation 2.

The fiber laser 1B illustrated in FIGS. 5A and 5B is different from the fiber laser 1 illustrated in FIG. 1 in method of realizing a mechanism for switching between operation modes (corresponding to an “operation mode switching mechanism” in the claims).

According to the fiber laser 1 illustrated in FIG. 1, switching between the operation modes is realized by changing the reflection wavelength band of the first low-reflective mirror 12a or the reflection wavelength band of the second low-reflective mirror 12b. In contrast, according to the fiber laser 1B illustrated in FIGS. 5A and 5B, switching between the operation modes is realized by changing a loss of an optical waveguide which constitutes a first resonator Oa or a loss of an optical waveguide which constitutes a second resonator Ob.

FIG. 5A illustrates the fiber laser 1B in a state where the loss of the optical waveguide which constitutes the first resonator Oa is increased by imparting a bend to an optical fiber located between a second high-reflective mirror 13b and a first low-reflective mirror 12a (by reducing a bend radius of the optical fiber). In this case, a gain of the second resonator Ob is higher than a gain of the first resonator Oa, and thus a second operation mode is realized. Further, as illustrated in FIG. 5A, the optical fiber to which the bend is imparted is connected to a light source group-side output port 14az of a first pump combiner 14a, and is an optical fiber which pumping light does not enter (or, even if pumping light enters, power of the pumping light is low to such an extent that the power can be ignored). Therefore, it is possible to prevent occurrence of leakage of pumping light from a bent part. Note that the fiber laser 1B may include, as a mechanism for switching an operation mode to the second operation mode, a mechanism (not illustrated in FIGS. 5A and 5B) for imparting the bend to the optical fiber located between the second high-reflective mirror 13b and the first low-reflective mirror 12a. It is also possible to increase the loss of the optical waveguide which constitutes the first resonator Oa, by applying lateral pressure to the optical fiber located between the second high-reflective mirror 13b and the first low-reflective mirror 12a, instead of or in addition to imparting the bend to the optical fiber. In this case, the fiber laser 1B may include, as a mechanism for switching the operation mode to the second operation mode, a mechanism (not illustrated in FIGS. 5A and 5B) for applying lateral pressure to the optical fiber located between the second high-reflective mirror 13b and the first low-reflective mirror 12a.

FIG. 5B illustrates the fiber laser 1B in a state where the loss of the optical waveguide which constitutes the second resonator Ob is increased by imparting a bend to an optical fiber located between a first high-reflective mirror 13a and a second low-reflective mirror 12b (by reducing a bend radius of the optical fiber). In this case, the gain of the first resonator Oa is higher than a gain of the second resonator Ob, and thus a first operation mode is realized. Further, as illustrated in FIG. 5B, the optical fiber to which the bend is imparted is connected to a light source group-side output port 14bz of a second pump combiner 14b, and is an optical fiber which pumping light does not enter (or, even if pumping light enters, power of the pumping light is low to such an extent that the power can be ignored). Therefore, it is possible to prevent occurrence of leakage of pumping light from a bent part. Note that the fiber laser 1B may include, as a mechanism for switching the operation mode to the first operation mode, a mechanism (not illustrated in FIGS. 5A and 5B) for imparting the bend to the optical fiber located between the first high-reflective mirror 13a and the second low-reflective mirror 12b. It is also possible to increase the loss of the optical waveguide which constitutes the second resonator Ob, by applying lateral pressure to the optical fiber located between the first high-reflective mirror 13a and the second low-reflective mirror 12b, instead of or in addition to imparting the bend to the optical fiber. In this case, the fiber laser 1B may include, as a mechanism for switching the operation mode to the first operation mode, a mechanism (not illustrated in FIGS. 5A and 5B) for applying lateral pressure to the optical fiber located between the first high-reflective mirror 13a and the second low-reflective mirror 12b.

(Variation 3 of Fiber Laser)

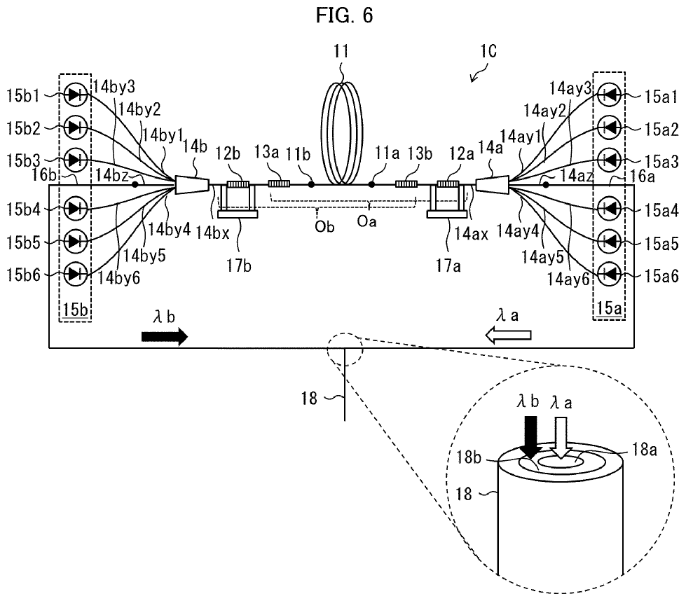

Variation 3 of the fiber laser 1 (hereinafter, also referred to as a “fiber laser 1C”) will be described below with reference to FIG. 6. FIG. 6 is a block diagram illustrating a configuration of a fiber laser 1C in accordance with Variation 3.

The fiber laser 1C illustrated in FIG. 6 is different from the fiber laser 1 illustrated in FIG. 1 in a method of outputting laser light.

The fiber laser 1 illustrated in FIG. 1 is configured such that the laser light which has the wavelength of λa and which has been recursively amplified in the first resonator Oa is outputted from the first delivery fiber 16a and the laser light which has the wavelength of λb and which has been recursively amplified in the second resonator Ob is outputted from the second delivery fiber 16b. In contrast, the fiber laser 1C illustrated in FIG. 6 is configured such that laser light which has a wavelength of λa and which has been recursively amplified in a first resonator Oa and laser light which has a wavelength of λb and which has been recursively amplified in a second resonator Ob are outputted from an output fiber 18.

According to the fiber laser 1C in accordance with Variation 3, an optical fiber which has (i) a first core 18a having a columnar or tubular shape (cylindrical shape in Variation 3) and (ii) a second core 18b having a tubular shape (cylindrical shape in Variation 3) and surrounding the first core is employed as the output fiber 18. The laser light which has the wavelength of λa and which has been recursively amplified in the first resonator Oa and guided through a first delivery fiber 16a is coupled with the first core 18a of the output fiber 18. The laser light which has the wavelength of λb and which has been recursively amplified in the second resonator Ob and guided through a second delivery fiber 16b is coupled with the second core 18b of the output fiber 18. This allows two types of laser beams which are different in wavelength and beam diameter to be outputted from an opposite end of the output fiber 18.

Note that a core of the first delivery fiber 16a and the first core 18a of the output fiber 18 may be fused together or spatially coupled. Similarly, a core of the second delivery fiber 16b and the second core 18b of the output fiber 18 may be fused together or spatially coupled. Also, a configuration may be employed in which the laser light which has the wavelength of λa and which has been guided through the first delivery fiber 16a is coupled with the second core 18b of the output fiber 18, instead of the first core 18a of the output fiber 18. In this case, a configuration may be employed in which the laser light which has the wavelength of λb and which has been guided through the second delivery fiber 16b is coupled with the first core 18a of the output fiber 18, instead of the second core 18b of the output fiber 18. Note that, in this case, the core of the first delivery fiber 16a and the second core 18b of the output fiber 18 may be fused together or spatially coupled. Similarly, the core of the second delivery fiber 16b and the first core 18a of the output fiber 18 may be fused together or spatially coupled.

It is also possible to realize a fiber laser as below. That is, it is also possible to realize a “fiber laser including: a gain fiber; a first low-reflective mirror and a second low-reflective mirror which are provided in an optical path of laser light emitted from a first end of the gain fiber; and at least one high-reflective mirror which is provided in an optical path of laser light emitted from a second end of the gain fiber, the fiber laser being capable of causing at least part of a reflection wavelength band of the first low-reflective mirror to overlap at least part of a reflection wavelength band of any of the at least one high-reflective mirror and being capable of causing at least part of a reflection wavelength band of the second low-reflective mirror to overlap at least part of the reflection wavelength band of any of the at least one high-reflective mirror”. According to such a fiber laser, it is possible to output laser light having different wavelengths from one side of the fiber laser. Such a fiber laser can be realized by, for example, exchanging the first high-reflective mirror 13a and the second high-reflective mirror 13b in the fiber laser 1 illustrated in FIG. 1.

Aspects of the present invention can also be expressed as follows:

A fiber laser in accordance with one or more embodiments of the present invention has a configuration in which the fiber laser includes: a gain fiber; a first low-reflective mirror and a second high-reflective mirror which are provided in an optical path of laser light that is emitted from a first end of the gain fiber; and a second low-reflective mirror and a first high-reflective mirror which are provided in an optical path of laser light that is emitted from a second end of the gain fiber, the fiber laser being capable of causing at least part of a reflection wavelength band of the first low-reflective mirror to overlap at least part of a reflection wavelength band of the first high-reflective mirror, being capable of causing at least part of a reflection wavelength band of the second low-reflective mirror to overlap at least part of a reflection wavelength band of the second high-reflective mirror, and causing the reflection wavelength band of the first high-reflective mirror not to overlap the reflection wavelength band of the second high-reflective mirror.

According to the above configuration, by causing at least part of the reflection wavelength band of the first low-reflective mirror to overlap at least part of the reflection wavelength band of the first high-reflective mirror, it is possible to output, from a first low-reflective mirror side, the laser light which has a first wavelength belonging to an overlap between these two reflection wavelength bands. Furthermore, according to the above configuration, by causing at least part of the reflection wavelength band of the second low-reflective mirror to overlap at least part of the reflection wavelength band of the second high-reflective mirror, it is possible to output, from a second low-reflective mirror side, the laser light which has a second wavelength belonging to an overlap between these two reflection wavelength bands. That is, according to the above configuration, it is possible to realize a fiber laser which is capable of outputting, from both sides thereof, laser light having different wavelengths.

The fiber laser in accordance with one or more embodiments of the present invention has, in addition to the configuration of the fiber laser in accordance with the above-described embodiments, a configuration in which the fiber laser has a first operation mode and a second operation mode, the first operation mode being a mode in which the laser light that has a first wavelength and that has been recursively amplified by a first resonator, which is constituted by the first low-reflective mirror and the first high-reflective mirror, and has passed through the first low-reflective mirror is outputted, the second operation mode being a mode in which the laser light that has a second wavelength and that has been recursively amplified by a second resonator, which is constituted by the second low-reflective mirror and the second high-reflective mirror, and has passed through the second low-reflective mirror is outputted; and the fiber laser further includes an operation mode switching mechanism which switches between the first operation mode and the second operation mode.

According to the above configuration, it is possible to freely switch between the first operation mode, in which the laser light having the first wavelength is outputted from the first low-reflective mirror side, and the second operation mode, in which the laser light having the second wavelength is outputted from the second low-reflective mirror side.

The fiber laser in accordance with one or more embodiments of the present invention has, in addition to the configuration of the fiber laser in accordance with the above-described embodiments, a configuration in which the operation mode switching mechanism switches between the first operation mode and the second operation mode by changing the reflection wavelength band of at least one mirror among the first low-reflective mirror, the second low-reflective mirror, the first high-reflective mirror, and the second high-reflective mirror.

According to the above configuration, it is possible to more reliably switch between the first operation mode, in which the laser light having the first wavelength is outputted from the first low-reflective mirror side, and the second operation mode, in which the laser light having the second wavelength is outputted from the second low-reflective mirror side.

The fiber laser in accordance with one or more embodiments of the present invention has, in addition to the configuration of the fiber laser in accordance with the above-described embodiments, a configuration in which the at least one mirror is constituted by a fiber Bragg grating; and the operation mode switching mechanism changes a reflection wavelength band of the fiber Bragg grating by changing tension acting on the fiber Bragg grating or by changing a temperature of the fiber Bragg grating.

According to the above configuration, it is possible to more reliably and more easily switch between the first operation mode, in which the laser light having the first wavelength is outputted from the first low-reflective mirror side, and the second operation mode, in which the laser light having the second wavelength is outputted from the second low-reflective mirror side.

The fiber laser in accordance with one or more embodiments of the present invention has, in addition to the configuration of the fiber laser in accordance with the above-described embodiments, a configuration in which the operation mode switching mechanism switches between the first operation mode and the second operation mode by changing a loss of an optical waveguide which constitutes the first resonator or changing a loss of an optical waveguide which constitutes the second resonator.

According to the above configuration, it is possible to more reliably switch between the first operation mode, in which the laser light having the first wavelength is outputted from the first low-reflective mirror side, and the second operation mode, in which the laser light having the second wavelength is outputted from the second low-reflective mirror side.

The fiber laser in accordance with one or more embodiments of the present invention has, in addition to the configuration of the fiber laser in accordance with any of the above-described embodiments, a configuration in which the second high-reflective mirror and the first low-reflective mirror are disposed so that the second high-reflective mirror is closer to the first end of the gain fiber than the first low-reflective mirror.

According to the above configuration, the first low-reflective mirror is disposed outside the second resonator which is constituted by the second low-reflective mirror and the second high-reflective mirror. Therefore, it is possible to prevent the first low-reflective mirror from (i) increasing a loss of the optical waveguide which constitutes the second resonator and (ii) preventing recursive amplification of laser light in the second resonator.

The fiber laser in accordance with one or more embodiments of the present invention has, in addition to the configuration of the fiber laser in accordance with the above-described embodiments, a configuration in which a first pump combiner which is for supplying pumping light to the gain fiber through the first end is provided between the second high-reflective mirror and the first low-reflective mirror.

According to the above configuration, it is possible to suppress (i) a reduction in long-term reliability of the first low-reflective mirror which reduction in long-term reliability can be caused by pumping light passing through the first low-reflective mirror and (ii) a loss of the pumping light.

The fiber laser in accordance with one or more embodiments of the present invention has, in addition to the configuration of the fiber laser in accordance with any one of the above-described embodiments, a configuration in which the first high-reflective mirror and the second low-reflective mirror are disposed so that the first high-reflective mirror is closer to the second end of the gain fiber than the second low-reflective mirror.

According to the above configuration, the second low-reflective mirror is disposed outside the first resonator which is constituted by the first low-reflective mirror and the first high-reflective mirror. Therefore, it is possible to prevent the second low-reflective mirror from (i) increasing a loss of the optical waveguide which constitutes the first resonator and (ii) preventing recursive amplification of laser light in the first resonator.

The fiber laser in accordance with one or more embodiments of the present invention has, in addition to the configuration of the fiber laser in accordance with the above-described embodiments, a configuration in which a second pump combiner which is for supplying pumping light to the gain fiber through the second end is provided between the first high-reflective mirror and the second low-reflective mirror.

According to the above configuration, it is possible to suppress (i) a reduction in long-term reliability of the second low-reflective mirror which reduction in long-term reliability can be caused by pumping light passing through the second low-reflective mirror and (ii) a loss of the pumping light.

The fiber laser in accordance with one or more embodiments of the present invention has, in addition to the configuration of the fiber laser in accordance with any one of the above-described embodiments, a configuration in which the fiber laser further includes an output fiber which has a first core and a second core that surrounds the first core; and the laser light which has passed through the first low-reflective mirror is coupled with the first core and the laser light which has passed through the second low-reflective mirror is coupled with the second core, or the laser light which has passed through the first low-reflective mirror is coupled with the second core and the laser light which has passed through the second low-reflective mirror is coupled with the first core.

According to the above configuration, it is possible to realize a fiber laser which is capable of outputting, from the output fiber, a first laser beam having a small beam diameter and a second laser beam having a large beam diameter.

Note that, in a case where it is intended to obtain the above effect with use of a conventional fiber laser configured such that laser light can be outputted from only one side of a gain fiber, it is necessary to use two sets of gain fibers and pumping light sources, and therefore use efficiency of the gain fibers and the pumping light sources may be decreased. In contrast, in a case where it is intended to obtain the above effect with use of the fiber laser in accordance with one or more embodiments of the present invention which is configured such that laser light can be outputted from both sides of the gain fiber, it is sufficient to use a single set of a gain fiber and a pumping light source, and therefore use efficiency of the gain fiber and the pumping light source being decreased is less likely to occur.

According to a method of outputting laser light in accordance with one or more embodiments of the present invention, a configuration is employed in which the method includes: a first step of outputting laser light which has been recursively amplified by a first resonator and has passed through a first low-reflective mirror, the first resonator being constituted by the first low-reflective mirror which is provided in an optical path of laser light that is emitted from a first end of a gain fiber and a first high-reflective mirror which is provided in an optical path of laser light that is emitted from a second end of the gain fiber; and a second step of outputting laser light which has been recursively amplified by a second resonator and has passed through a second low-reflective mirror, the second resonator being constituted by the second low-reflective mirror which is provided in the optical path of the laser light that is emitted from the second end of the gain fiber and a second high-reflective mirror which is provided in the optical path of the laser light that is emitted from the first end of the gain fiber.

According to the above configuration, it is possible to, in the first step, output, from a first low-reflective mirror side, laser light having a first wavelength belonging to an overlap between a reflection wavelength band of the first low-reflective mirror and a reflection wavelength band of the first high-reflective mirror. Further, according to the above configuration, it is possible to, in the second step, output, from a second low-reflective mirror side, laser light having a second wavelength belonging to an overlap between a reflection wavelength band of the second low-reflective mirror and a reflection wavelength band of the second high-reflective mirror. That is, according to the above configuration, it is possible to realize a method of outputting laser light which method allows laser light having different wavelengths to be outputted from both sides.

(Supplementary Note)

Although the disclosure has been described with respect to only a limited number of embodiments, those skilled in the art, having benefit of this disclosure, will appreciate that various other embodiments may be devised without departing from the scope of the present invention. Accordingly, the scope of the invention should be limited only by the attached claims.

### REFERENCE SIGNS LIST

1 Fiber laser
11 Gain fiber
12a First low-reflective mirror
12b Second low-reflective mirror
13a First high-reflective mirror
13b Second high-reflective mirror
14a First pump combiner
14b Second pump combiner
15a First pumping light source group
15b Second pumping light source group
16a First delivery fiber
16b Second delivery fiber
17a First reflection wavelength band changing mechanism (operation mode switching mechanism)
17b Second reflection wavelength band changing mechanism (operation mode switching mechanism)
18 Output fiber
Oa First resonator
Ob Second resonator

1. A fiber laser comprising:
a gain fiber;
a first low-reflective mirror and a second low-reflective mirror:
a first high-reflective mirror and a second high-reflective mirror, wherein
the first low-reflective mirror and the second high-reflective mirror are disposed in an optical path of laser light that is emitted from a first end of the gain fiber;
the second low-reflective mirror and the first high-reflective mirror are disposed in an optical path of laser light that is emitted from a second end of the gain fiber;
a first delivery fiber that accepts the laser light emitted from the first end;
a second delivery fiber that accepts the laser light emitted from the second end; and
an operation mode switching mechanism that switches between a first operation mode and a second operation mode, wherein
a first resonator is constituted by the first low-reflective mirror and the first high-reflective mirror,
a second resonator is constituted by the second low-reflective mirror and the second high-reflective mirror,
in the first operation mode, the first resonator recursively amplifies the laser light, and the first delivery fiber outputs the amplified laser light that has passed through the first low-reflective mirror,
in the second operation mode, the second resonator recursively amplifies the laser light, and the second delivery fiber outputs the amplified laser light that has passed through the second low-reflective mirror, and
the fiber laser is configured to cause:
at least part of a reflection wavelength band of the first low-reflective mirror to overlap at least part of a reflection wavelength band of the first high-reflective mirror,
at least part of a reflection wavelength band of the second low-reflective mirror to overlap at least part of a reflection wavelength band of the second high-reflective mirror, and
the reflection wavelength band of the first high-reflective mirror not to overlap the reflection wavelength band of the second high-reflective mirror.

2. The fiber laser as set forth in claim 1, wherein the operation mode switching mechanism switches between the first operation mode and the second operation mode by changing the reflection wavelength band of at least one mirror among the first low-reflective mirror, the second low-reflective mirror, the first high-reflective mirror, and the second high-reflective mirror.

3. The fiber laser as set forth in claim 2, wherein:
the at least mirror is constituted by a fiber Bragg grating; and
the operation mode switching mechanism changes a reflection wavelength band of the fiber Bragg grating by changing tension acting on the fiber Bragg grating or by changing a temperature of the fiber Bragg grating.

4. The fiber laser as set forth in claim 1, wherein the operation mode switching mechanism switches between the first operation mode and the second operation mode by:
changing a loss by imparting a bend to an optical waveguide that constitutes the first resonator or the second resonator; and/or
changing the loss by applying lateral pressure to the optical waveguide that constitutes the first resonator or the second resonator.

5. The fiber laser as set forth in claim 1, wherein the second high-reflective mirror and the first low-reflective mirror are disposed such that the second high-reflective mirror is closer to the first end of the gain fiber than the first low-reflective mirror.

6. The fiber laser as set forth in claim 5, wherein a first pump combiner that supplies pumping light to the gain fiber through the first end is disposed between the second high-reflective mirror and the first low-reflective mirror.

7. The fiber laser as set forth claim 1, wherein the first high-reflective mirror and the second low-reflective mirror are disposed such that the first high-reflective mirror is closer to the second end of the gain fiber than the second low-reflective mirror.

8. The fiber laser as set forth in claim 7, wherein a second pump combiner that supplies pumping light to the gain fiber through the second end is disposed between the first high-reflective mirror and the second low-reflective mirror.

9. The fiber laser as set forth in claim 1, further comprising:
an output fiber including a first core and a second core that surrounds the first core, wherein:
the laser light output from the first delivery fiber is coupled with the first core and the laser light output from the second delivery fiber is coupled with the second core; or
the laser light output from the first delivery fiber is coupled with the second core and the laser light output from the second delivery fiber is coupled with the first core.

10. A method of outputting laser light, comprising:
outputting, from a first delivery fiber, laser light that has been recursively amplified by a first resonator and that has passed through a first low-reflective mirror,
wherein the first resonator is constituted by:
the first low-reflective mirror disposed in an optical path of laser light that is emitted from a first end of a gain fiber; and
a first high-reflective mirror disposed in an optical path of laser light that is emitted from a second end of the gain fiber;
outputting, from a second delivery fiber, laser light that has been recursively amplified by a second resonator and that has passed through a second low-reflective mirror,
wherein the second resonator being constituted by:
the second low-reflective mirror disposed in the optical path of the laser light that is emitted from the second end of the gain fiber; and
a second high-reflective mirror disposed in the optical path of the laser light that is emitted from the first end of the gain fiber; and
switching between the outputting from the first delivery fiber and the outputting from the second delivery fiber.
